(19) United States
(12) Patent Application Publication
(10) Pub. No.: US 2005/0154847 A1
(43) Pub. Date: Jul. 14, 2005

(54) Mirrored data storage system

(75) Inventor: Richard John Trembecki, Bristol (GB)

Correspondence Address: NIXON & VANDERHYE, PC, 1100 N GLEBE ROAD, 8TH FLOOR, ARLINGTON, VA, 22201-4714, US

(73) Assignee: ELIPSAN LIMITED

(21) Appl. No.: 10/756,766

(22) Filed: Jan. 14, 2004

(51) Int. Cl. G06F 12/16

(52) U.S. Cl. 711/162

(57) ABSTRACT

A disk mirror data storage system which includes a plurality of mirror facets, at least one local and at least one remote accessed by an IP network. The system includes a mirror volume manager which, in response to a request to store data, performs a synchronous write of the data to the local mirror facet, and an asynchronous write of data to the remote mirror facet. The data to be stored is also written to a locally maintained buffer where it is kept until the asynchronous write to the remote facet has completed. This allows the system to report completion of the write operation after synchronous write to the local facet, and without waiting for the asynchronous write to the remote facet to complete.

### BACKGROUND OF THE INVENTION

The present invention relates to data storage for computer systems, and in particular to a technique known as mirroring where data is stored in duplicate in more than one location.

Many computer systems consist of a number of computers connected to each other using a network (e.g. Ethernet). Such computers usually each have their own local data storage (most often one or more hard disk drives) and may also have access to shared data storage connected to the network. In many cases it is important for computer users, or applications, to be able to share data with other users or applications. This data may be stored on the local disk of one of the computers on the network or on the shared data storage, also on the network. Where many users are trying to use data on the same shared data storage device, the time required for writing and retrieving data can increase, causing frustration to the users.

Another important consideration for data storage is the security and reliability of the storage. Hard disk drives are mechanical systems and may fail in use. Important data must be stored in such a way that it is still available if any one disk (or in some cases network of disks) fails. For this reason data storage networks (often referred to as Storage Area Networks) are commonly designed to withstand failure of individual disks with no loss of data or availability.

Discussion of the Prior Art

One technique for improving both data security and also accessibility to data is known as mirroring. This involves storing data in duplicate in more than one location (known as mirror facets). Data security is further enhanced if the mirror facets are not physically co-located as this reduces the risk of large scale data loss in the event of catastrophes such as fire or earthquake etc. Many systems exist offering data duplication using mirroring across a number of disks and such mirroring may be applied at a number of levels using different technologies or combinations of technologies. For example, one technique known as RAID (Redundant Array of Inexpensive Disks), offers low-level protection by distributing data across a number of disks in a redundant manner such that the failure of any one disk (or in some cases several disks) does not result in loss of data or availability. A higher level protection is offered by fully mirroring disks or arrays of disks at a disk or volume level. A “volume” may consist of a part of a disk, a single disk or a number of physical disks, but it is managed in such a way that the operating system can treat it as if it were one very large disk. It may also be distributed across all or parts of a number of disks, and the disks themselves may be RAID arrays. Such volume mirroring is a technique which is well supported by many common operating systems, such as Windows 2000 and Windows NT.

FIG. 1 of the accompanying drawings illustrates schematically volume mirroring using a two-way local mirror. The operating system will regard the two way local mirror illustrated in FIG. 1 as a single volume, i.e. equivalent to a single drive (e.g. the D drive). It will initiate write requests for the storage of data, or read requests to retrieve data, to the volume and these are processed by the mirror volume manager 1 which is the interface between the actual data storage and the operating system. The two way local mirror of FIG. 1 writes the data to be stored to two different data stores 3 and 5 which are known as mirror facets. The two facets are identical to each other in terms of the data stored because every write request is executed on both facets. In response to each write request, the local mirror facets 3a and 5a write the data to the disk storage 3b, 5b, which can be in the form of pools of disks 3c, 5c. Because a volume mirror consists of two or more identical images of the same data, and it is of vital importance that the facets of the mirror are kept in constant synchronisation with no differences between them at any time, all of the duplicated write operations across the mirror must complete before a response is sent to the initiator of the original write request. This is known as “synchronous action” because the state of all facets of the mirror are identical once the response to the original request has been sent.

A read request directed to the mirror volume manager from the operating system will be served by only one of the facets. It is possible, therefore, for the mirror volume manager 1 to perform load balancing by dividing read requests from the operating system amongst the two facets.

As discussed above it is advantageous for data security if one of the mirror facets is remote from the mirror volume manager. However, because each write operation must write the data to each of the mirror locations and the application running on the operating system cannot continue until the write operation is complete on all facets, currently remote volume mirrors require high-bandwidth network connections to the remote mirror with guaranteed latency (response time) and bandwidth. Otherwise unacceptably long delays are caused to the operating system by waiting for the indeterminate amount of time needed to communicate with the remote mirror.

The requirement for high-bandwidth connections with guaranteed latency to remote mirror facets, though, means that volume mirroring is expensive. It would be desirable if lower cost communications links to remote mirrors could be used, but a link over an IP (internet protocol) network, such as the Internet, for example, is unsuitable for volume mirroring because it has variable and indeterminate latency and bandwidth. Furthermore, it is well known that connections over the Internet are susceptible to failure.

An additional or alternative technique for improving data security is to regularly back-up data, and commercial remote backup services are available. However, backing up data differs significantly from mirroring because it does not involve the maintenance of two identical images of the data. Instead, from time to time, a copy of the data on the main data store is made and sent to the backup. Thus backups are out of date for almost all of the time. Furthermore backups are only used in case the main data store fails: they are not, and cannot be, utilized for load balancing with regard to read requests. Thus although they provide for some data security, they do not provide the advantages of mirroring. In fact backing-up of data would often be used regardless of the presence or not of mirrored storage.

### SUMMARY OF THE INVENTION

The invention provides a remote mirroring data storage system which can use a remote facet on a network of low, variable and indeterminate latency and bandwidth, without compromising performance significantly. In more detail it provides a mirrored data storage system comprising a mirror volume manager for managing the storage of data on, and the retrieval of data from, a plurality of mirror facets of at least one mirrored data storage volume, said plurality of mirror facets comprising a first mirror facet local to the mirror volume manager and a second mirror facet remote from the mirror volume manager and connected to the mirror volume manager by a communications link, wherein in response to a request to store data the mirror volume manager performs a synchronous write of the data to be stored to the first mirror facet whereupon it reports completion of said request, and an asynchronous write of the data to be stored, buffered if necessary, to the second mirror facet.

Preferably the data to be stored is always buffered, a data storage buffer being provided local to the mirror volume manager. The data to be stored is then stored in the data storage buffer until completion of the asynchronous write.

Thus the buffering of the data allows the use of an asynchronous write operation in a volume mirror without loss of security. Furthermore, the use of the asynchronous write operation does not slow down the performance of the initiator of the write request because the response that the write has been completed is given as soon as the synchronous write to the local mirror has been completed, which will normally be before the asynchronous write has been completed (depending on the performance of the connection to the remote facet).

Thus the communications link to the remote facet can have variable latency and bandwidth, and so can use an IP network, such as the Internet.

Any or all of the mirror facets may comprise disk based storage, for example a plurality of disks, such as a RAID system.

More than one local or remote mirror facet may be provided.

The control of the data storage system of the invention may be performed by software on a general purpose computer and thus the invention extends to software for providing the mirrored data storage system of the invention.

### BRIEF DESCRIPTION OF THE ACCOMPANYING DRAWINGS

The invention will be further described by way of example with reference to the accompanying drawings in which:—

FIG. 1 illustrates a prior art two-way local mirror;

FIG. 2 illustrates a two-way remote asynchronous mirror according to the first embodiment of the invention;

FIG. 3 illustrates a three-way remote asynchronous mirror according to a second embodiment of the invention;

FIG. 4 illustrates a one-way remote asynchronous mirror;

FIG. 5 illustrates a three-way mirror with local and remote asynchronous mirrors according to a third embodiment of the invention;

FIG. 6 illustrates a synchronous and asynchronous write message sequence; and

FIG. 7 illustrates a synchronisation message sequence.

### DESCRIPTION OF PREFERRED EMBODIMENTS

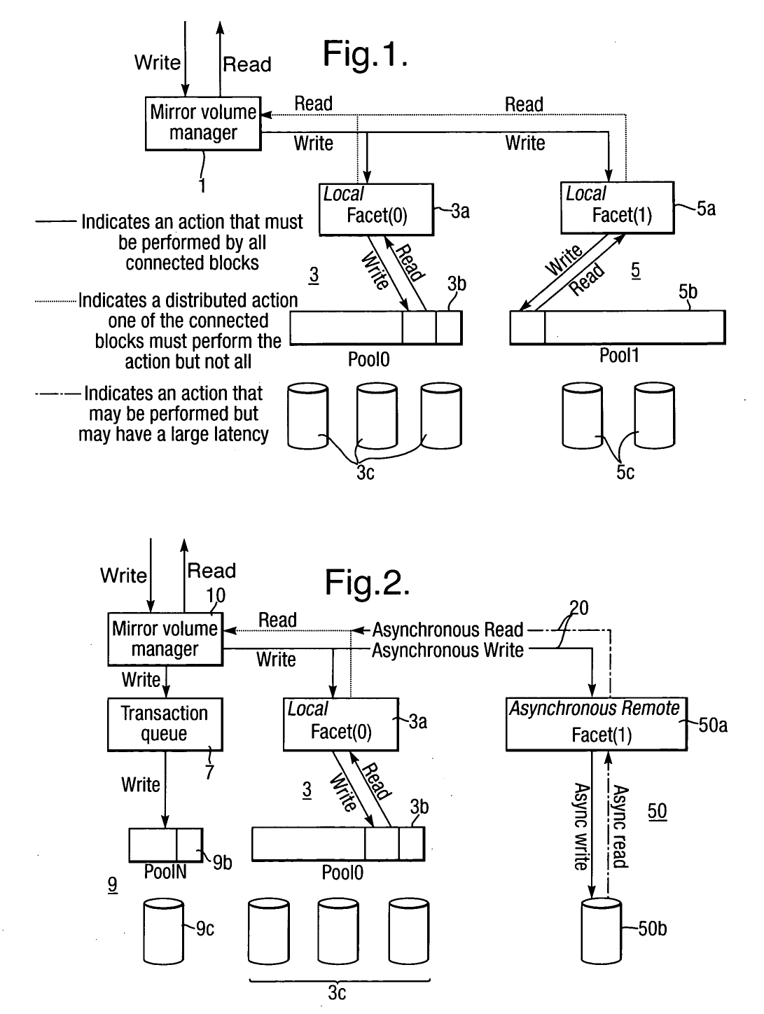

FIG. 2 illustrates a two-way remote asynchronous mirror in accordance with first embodiment of the invention. The mirror system is controlled by a mirror volume manager 10 which, as in the mirror system of FIG. 1, acts as an interface to the operating system which initiates read and write requests to the data storage. The system of FIG. 2 includes a single local mirror facet 3 which operates in exactly the same way as the local mirror facet of the prior art system of FIG. 1. However the second mirror facet 50 is provided remotely from the mirror volume manager and local facet 3. The remote facet 50 consists of a local manager 50a and data storage 50b, such as an array of disks and is linked to the mirror volume manager by a communications link 20 which may be provided over the Internet or another IP network. Thus read and write operations to the remote facet 50 are conducted asynchronously as will be explained below.

The system further includes a transaction queue 7 and data store 9 consisting of a pool of disks 9b, such as an array of disks 9c, which provide a buffering operation for the data to be stored. When a write request is received by the mirror volume manager 10, the data is written directly to the local mirror facet 3, also to the transaction queue 7 and then to the buffer 9, and in addition to the remote mirror 50 via the IP network. The mirror volume manager 10 reports completion of the write operation to the operating system as soon as the synchronous writes to the local mirror facet 3 and through the transaction queue 7 have been completed. It does not wait for completion of the asynchronous write operation to the remote mirror facet 50.

The data to be stored is buffered by being maintained in the transaction queue 7 and, if necessary, data store 9 until the asynchronous write has been completed, and thus the remote mirror facet 50 is fully synchronised.

In response to a read request from the operating system the mirror volume manager 10 will usually read data from the local mirror facet 3. However if the local mirror facet 3 is unavailable, the data can be read from the remote mirror 50 if it is in the synchronised state, or from the buffer if the remote mirror has not yet been synchronised.

Thus the system can provide the advantages of remote volume mirroring without needing a high cost communications link to the remote mirror.

It will be appreciated that at any given time the remote mirror facet 50 can be in one of three states:
1. Synchronised: The data has been successfully written to the remote mirror facet 50 so it is identical to the local mirror 3.
2. Not Synchronised: The write to the remote mirror facet 50 has failed and the remote mirror facet 50 must be rewritten with a bit-wise copy of the local mirror facet 3 in order to become synchronised.
3. Being Synchronised: The write to the remote mirror facet 50 is in progress, so if the local mirror facet 3 fails, data must be read from the buffer.

If it happens that much data is to be written, and the communications link 20 is slow, it may be that the data store 9 overflows. In this case either the write operation submitted to the remote mirror facet 50 will be blocked until space becomes available in the buffer, or: the remote mirror facet 50 is forced to the not-synchronised state, the buffer is emptied and any write commands being sent to the remote mirror facet 50 will be suspended.

The transaction queue 7 is thus primarily used to buffer write requests to the remote asynchronous mirror facets. It stores information about the address of the data to be changed and the actual change of data. It consists of an ordered list of transactions and each facet of the mirror has a reference to the head of a list of outstanding transactions, a reference to the tail of a list of outstanding transactions, a pointer to the tail of a list of outstanding transactions and a count of transactions. Each entry within the list contains information on the location in the mirror that has changed, the size of the change, the location within the data segment of the transaction queue 7 that the changed data resides in and the number of queues this entry is in.

Primarily only the remote asynchronous facet 50 uses the transaction queue 7 and associated data storage 9. However these can be used to buffer changes to the local mirror facet 3 if it is off line for any time (for example for maintenance). Because the transaction queue 7 stores a list of the changes which need to be made to the mirror facets, fast re-synchronisation of a facet is possible because only the data which has changed needs to be updated, rather than all of the data.

In a similar way, if an asynchronous write operation fails (e.g. because of a communications breakdown), the data which failed to be written can be replaced in the transaction queue 7 for a further attempt, for example when the communications link 20 is restored. Again, this reduces the number of times that the remote facet 50 has to be completely re-synchronised.

When an unsynchronised facet, such as remote facet 50, needs to be completely synchronised, this is performed by reading data from a synchronised facet, such as local facet 3. A record of progress of synchronisation is maintained to identify if any new write request received by the mirror volume manager in the meantime needs to be sent to the facet which is being synchronised, or can be ignored by that facet and served from elsewhere.

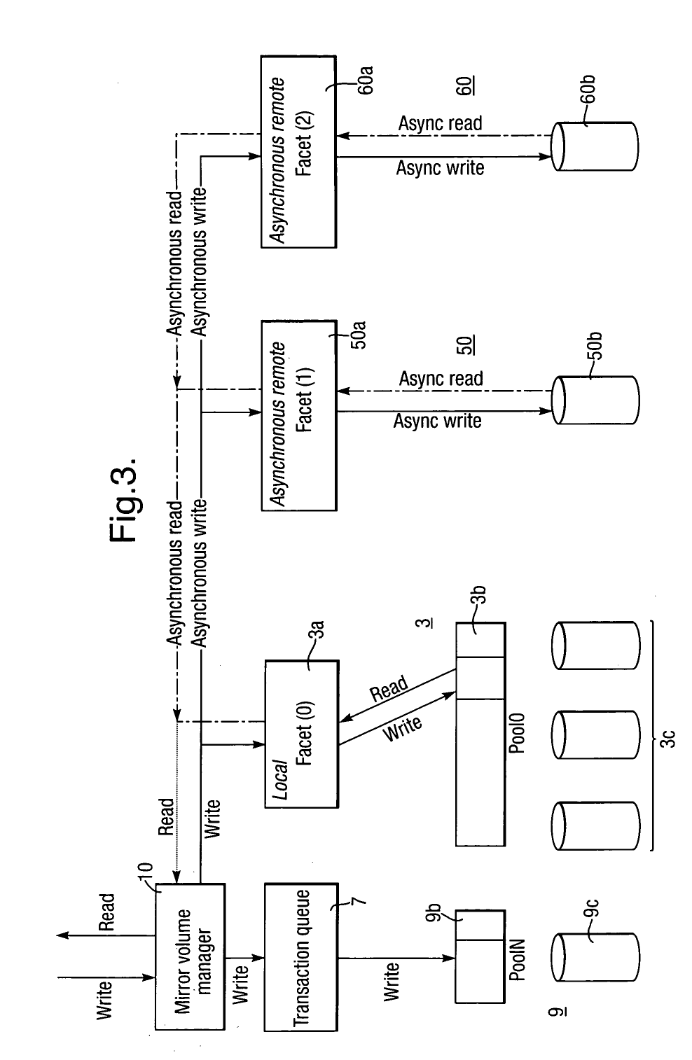

FIG. 3 illustrates a second embodiment of the invention in which a second remote mirror facet 60 is provided, identical in structure to first remote mirror facet 50, and which also communicates with mirror volume manager 10 by means of asynchronous read and write operations. The mirror facet 60 is maintained as an identical image of the data, just as is mirror facet 50, and so the operation of the embodiment of FIG. 3 is the same as that of FIG. 2.

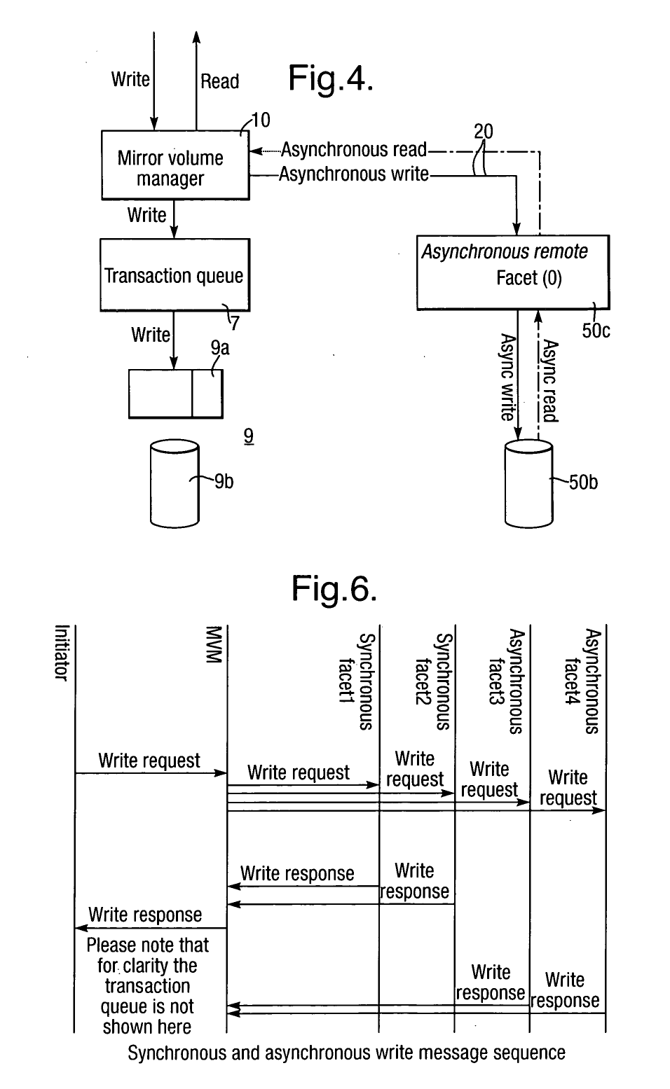

FIG. 4 illustrates the situation which can occur in which a local facet of the embodiment of FIG. 2 has been taken off line or failed. In this case the only available facet is the remote facet 50 and so all read and write operations are performed on the remote facet. Clearly in this case the read operations from the remote facet may have a large latency.

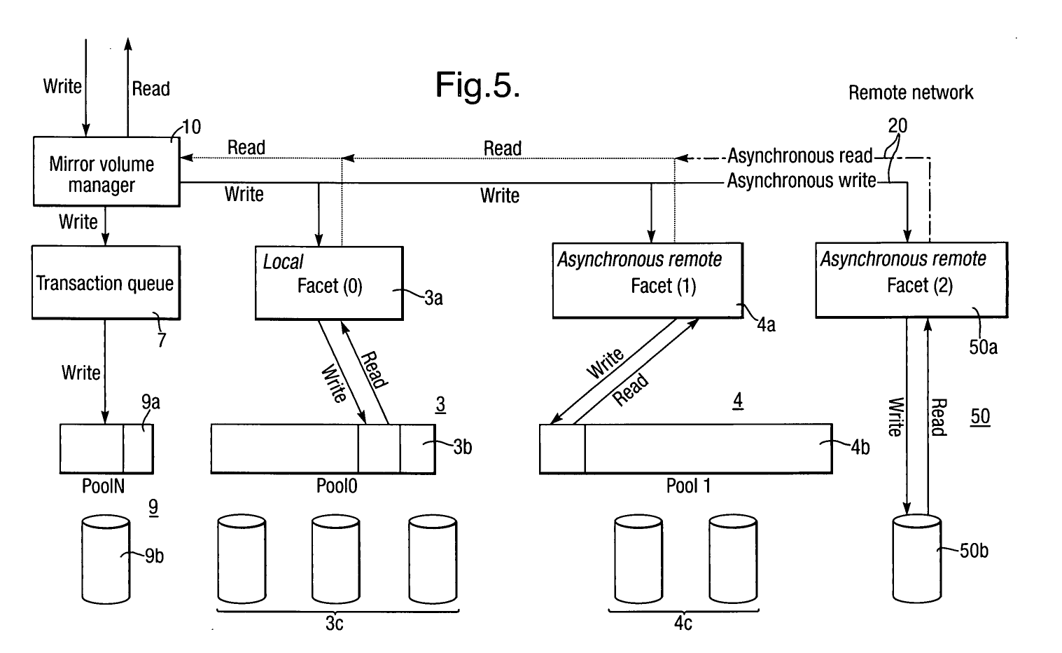

FIG. 5 illustrates a further embodiment of the invention in which two local mirror facets 3 and 4 are provided of similar structure. The operation of this embodiment is similar to that of the embodiments above, with the exception that there is an additional image of the data maintained in the second local facet 4.

It is necessary, of course, to provide for safe operation of the system in various failure scenarios. Errors in a local storage facet caused that facet to be taken off line and also to be marked as un-synchronised. It is synchronised fully when the reason for the error had been determined. However, if the failed local storage contains the transaction queue 7 and buffer 9, this has implications particularly for the remote facets. In this case all mirror facets that were using the transaction queue 7 for synchronisation must be marked as unsynchronised and any asynchronous remote mirror facet that had outstanding transactions must also be marked as unsynchronised. However any asynchronous remote mirror facets that did not have outstanding transactions can be accessed, but this must be done synchronously in view of the unavailability of the transaction queue and buffer.

In the case of one of the remote facets suffering failure or error, for instance because of network failure, power failure, reconfiguration of the remote host or disk failure or removals from the remote host, transactions are queued using either the transaction queue or, if the queue has filled, then a bitmap for fast synchronization is generated. In the event of a failed read from a facet, then an attempt to recover the lost data is made by reading the data from a different facet, returning the data to the initiator of the read request.

In the event of a failed read from a facet, then an attempt to recover the lost data is made by reading the data from a different facet, returning the data to the initiator of the read request, and also writing the data to the failed facet.

Various failure modes are set out below together with the actions taken by the system and the result.

| | | | |
|---|---|---|---|
| Configuration: | Local Facets: 1 | Remote Sync Facets: 0 | Remote Async |
| | | | Facets: 1 |

| | |
|---|---|
| Failure | Local disk fails containing the local facet. |
| Mechanism | Transaction queue is intact. |
| Result | The local facet is marked as unsynchronised |
| | Failure is transparent to initiator. Performance may |
| | degrade significantly. |
| Recovery | Replace the disk, add a new facet to the pool containing |
| | the new disk. Remove failed facet. |

| | | | |
|---|---|---|---|
| Configuration: | Local Facets: 1 | Remote Sync Facets: 0 | Remote Async |
| | | | Facets: 1 |

| | |
|---|---|
| Failure | Remote target is rebooted. |
| Mechanism | |
| Result | Outstanding writes to the remote target will be added to |
| | the head of the transaction queue. The transaction queue |
| | will fill with changes made to the mirror. |
| | Failure is transparent to initiator. Performance may |
| | degrade slightly when resynchronization is in progress. |
| Recovery | Automatic - once the remote target is back online the |
| | Mirror Volume Manager will resynchronise the |
| | unsynchronised facet. |

| | | | |
|---|---|---|---|
| Configuration: | Local Facets: 1 | Remote Sync Facets: 0 | Remote Async |
| | | | Facets: 1 |

| | |
|---|---|
| Failure | Remote target is offlined due to disk failure. |
| Mechanism | |
| Result | Outstanding writes to the remote target are added to the |
| | head of the transaction queue, new writes to the remote |
| | target are added to the tail of the queue. If the queue fills |
| | the facet is marked as unsynchronised and the queue to |
| | the facet is freed. |
| Recovery | Replace failed disk, recreate remote target initiate |
| | synchronisation to failed facet. |

FIG. 6 illustrates the synchronous and asynchronous write message sequence in a system with two synchronous facets and two asynchronous facets. For clarity the transaction queue 7 is not shown in FIG. 6, though as indicated above data to be written is passed through the transaction queue 7 to the buffer 9. The data is always submitted to the queue but the queue only writes to the buffer if the queue size reaches a pre-determined threshold.

It will be seen from FIG. 6 that the write response from the mirror volume manager 10 is sent to the initiator of the write request before the write responses are received from the asynchronous facets.

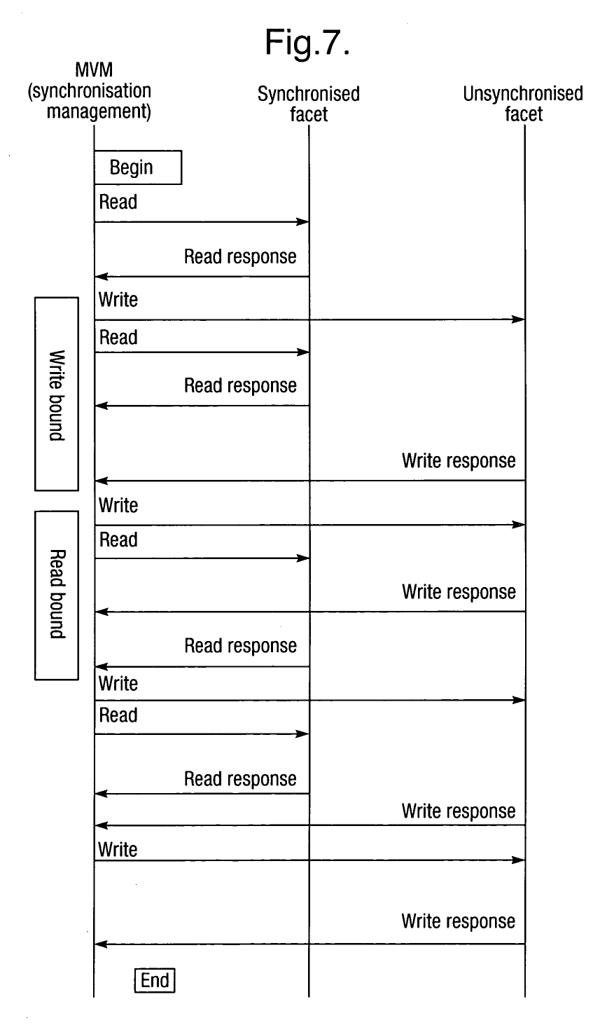

FIG. 7 illustrates the synchronization message sequence. As indicated there an unsynchronised facet will be synchronised by reading data from a synchronised facet and writing it to the unsynchronised facet. The synchronisation is initiated by the mirror volume manager 10, in particular the synchronisation management part thereof, which sends a read request to a synchronised facet. Once a response to the read request has been received, the synchronisation manager forwards the read data to the unsynchronised facet as a write command. The next read is then issued to the synchronised facet to obtain the next section of data being synchronised. The second read response from the synchronised facet will normally return before the first write response on the unsynchronised facet, and so the completed second write request using data from the synchronised facet is buffered. Once the first write response has been received from the unsynchronised facet, the second write request is sent to the unsynchronised facet, and a third read request issued to the synchronised facet. Again, the data received in response to the third read request will be buffered until the second write has been completed at the unsynchronised facet. This process continues until all required data has been sent to the unsynchronised facet and the unsynchronised facet can be marked as synchronised.

1. A mirrored data storage system comprising a mirror volume manager for managing the storage of data on, and the retrieval of data from, a plurality of mirror facets of at least one mirrored data storage volume, said plurality of mirror facets comprising a first mirror facet local to the mirror volume manager and a second mirror facet remote from the mirror volume manager and connected to the mirror volume manager by a communications link, wherein in response to a request to store data the mirror volume manager performs a synchronous write of the data to be stored to the first mirror facet whereupon it reports completion of said request, and an asynchronous write of the data to be stored, buffered if necessary, to the second mirror facet.

2. A mirrored data storage system according to claim 1 wherein the data to be stored is always buffered.

3. A mirrored data storage system according to claim 1 wherein a data storage buffer is provided local to said mirror volume manager for buffering said data to be stored.

4. A mirrored data storage system according to claim 3 wherein the data to be stored is stored in said data storage buffer until completion of the asynchronous write.

5. A mirrored data storage system according to claim 1 wherein said communications link has variable latency and bandwidth.

6. A mirrored data storage system according to claim 1 wherein said communications link uses an internet protocol.

7. A mirrored data storage system according to claim 1 wherein said communications link is over the Internet.

8. A mirrored data storage system according to claim 1 wherein at least one of said mirror facets comprises disk-based storage.

9. A mirrored data storage system according to claim 1 wherein at least one of said mirror facets comprises a plurality of data storage disks.

10. A mirrored data storage system according to claim 1 wherein at least one of said mirror facets comprises a RAID system.

11. A mirrored data storage system according to claim 1 wherein more than one local mirror facet is provided.

12. A mirrored data storage system according to claim 1 wherein more than one remote mirror facet is provided.
